(19) United States
(12) Patent Application Publication
(10) Pub. No.: US 2016/0294695 A1
(43) Pub. Date: Oct. 6, 2016

(54) PACKET TRANSMISSION APPARATUS

(71) Applicant: FUJITSU LIMITED, Kawasaki-shi (JP)

(72) Inventor: Takuya MAEDA, Kanazawa (JP)

(73) Assignee: FUJITSU LIMITED, Kawasaki-shi (JP)

(21) Appl. No.: 15/078,613

(22) Filed: Mar. 23, 2016

(30) Foreign Application Priority Data
Apr. 6, 2015 (JP) 2015-077587

(51) Int. Cl. H04L 12/741; H04L 12/755; G06F 17/30

(52) U.S. Cl. CPC H04L 45/745; G06F 17/30312; H04L 45/021

(57) ABSTRACT

A packet transmission apparatus receives a first packet identified by a first index. Upon a first determination on the presence of a first entry corresponding to the first index in a table storing entries corresponding to respective indices, the processor registers an entry into the table in absence of the first entry and updates the first entry in presence of the first entry. Upon a second determination on the presence of a third entry not updated for a first period of time in the table, the processor deletes the third entry in presence of the third entry. The processor skips the first determination when the first packet is received during a first time zone determined on basis of information indicating a reception state of packets identified by the first index. The processor skips the second determination for an entry corresponding to a packet received during the first time zone.

### CROSS-REFERENCE TO RELATED APPLICATION

This application is based upon and claims the benefit of priority of the prior Japanese Patent Application No. 2015-077587, filed on Apr. 6, 2015, the entire contents of which are incorporated herein by reference.

### FIELD

The embodiments discussed herein are related to a packet transmission apparatus.

### BACKGROUND

There is a packet transmission apparatus performing the media access control (MAC) address learning. The MAC address learning is processing in which transmission source information of a received packet is registered, before the packet is transferred to a destination, in a table as transfer destination information of a packet addressed to the transmission source of the above received packet. To determine a transfer destination of a received packet, the table is referred to. The table may be referred to as a forwarding table.

As an example, the MAC address learning is performed as follows: Search is performed by comparing transmission source information of the packet with all entries registered in the table. This checks whether the transmission source information has already been registered in the table. If no transfer destination information matching the transmission source information is registered in the table, the transmission source information is registered. The MAC address learning is performed for all packets received by the packet transmission apparatus regardless of whether they have been learnt or not.

Related techniques are disclosed in, for example, Japanese Laid-open Patent Publication No. 2005-109592, Japanese Laid-open Patent Publication No. 2006-074554, Japanese Laid-open Patent Publication No. 2012-235400, Japanese Laid-open Patent Publication No. 11-163914, and Japanese Laid-open Patent Publication No. 01-039852.

In recent years, as the number of network users increases, the number of entries to be registered in the table is increasing. Also, in response to increasing communication data amount of each user, communication speed tends to be faster. Accordingly, load of search in the MAC address learning increases. Normally, a packet is transferred to a destination after completion of the MAC address learning. For this reason, when search time becomes long, transmission timing of the packet delays. Such delay of the packet processing may cause decrease in throughput or packet discard due to packet retention. In other words, there is a possibility that load of the MAC address learning in a packet transmission apparatus affects packet transfer.

The aging processing is performed for suppressing increase of the number of entries. In the aging processing, for example, an entry not updated for a predetermined period of time is deleted from the table. With this processing, space for learning may be increased by deleting MAC address information which is learnt and not used. Also, the number of entries accessed in the MAC address learning may be reduced. As a matter of course, even in the aging processing, each entry is accessed to determine whether each entry is not updated for a predetermined period of time. For this reason, load of the aging processing tends to increase as the number of entries increases.

### SUMMARY

According to an aspect of the present invention, provided is a packet transmission apparatus including a storage unit and a processor. The storage unit is configured to store therein a first table storing therein entries corresponding to respective indices out of plural indices. The processor is configured to receive a first packet identified by a first index. The processor is configured to perform a first determination of determining whether a first entry corresponding to the first index is present in the first table. The processor is configured to register an entry corresponding to the first index into the first table in absence of the first entry in the first table. The processor is configured to update the first entry in presence of the first entry in the first table. The processor is configured to determine whether a second entry corresponding to a second index is present in the first table. The second index identifies a destination of the first packet. The processor is configured to transfer the first packet to the destination on basis of the second entry in presence of the second entry in the first table. The processor is configured to perform a second determination of determining whether a third entry is present in the first table. The third entry is not updated for a first period of time. The processor is configured to delete the third entry from the first table in presence of the third entry in the first table. The processor is configured to determine a first time zone on basis of information indicating a reception state of packets identified by the first index. The processor is configured to skip the first determination when the first packet is received during the first time zone. The processor is configured to set the first entry to a non-aging entry when the first packet is received during the first time zone. The processor is configured to skip the second determination for an entry set to the non-aging entry.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a network system according to an embodiment;

FIG. 2 is a diagram illustrating an exemplary configuration of a packet transmission apparatus in a network system;

FIG. 3 is a diagram illustrating MAC address learning according to a related technology;

FIG. 4 is a diagram illustrating a detail of MAC address learning according to a related technology;

FIG. 5 is a diagram illustrating a detail of MAC address learning according to a related technology;

FIG. 6 is a diagram illustrating a detail of MAC address learning according to a related technology;

FIG. 7 is a diagram illustrating a detail of MAC address learning according to a related technology;

FIG. 8 is a diagram illustrating a detail of MAC address learning according to a related technology;

FIG. 9 is a diagram illustrating problems in a related technology;

FIG. 10 is a diagram illustrating an exemplary configuration of a packet transmission apparatus according to an embodiment;

FIG. 11 is a graph indicating usage of a network;

FIG. 12 is a diagram illustrating an exemplary data structure of a statistical table stored in an FPGA;

FIG. 13 is a diagram illustrating an exemplary method of index search;

FIG. 14 is a diagram illustrating a change of temporal granularity in a statistical table and a threshold value;

FIG. 15 is a diagram illustrating operations of a statistical information analysis unit;

FIG. 16 is a diagram illustrating operations of a statistical information analysis unit;

FIG. 17 is a flowchart illustrating a flow of operations performed by a statistical information analysis unit;

FIG. 18 is a diagram illustrating an exemplary data structure of a decimation table;

FIG. 19 is a diagram illustrating operations of a decimation unit;

FIG. 20 is a flowchart illustrating an operation flow of MAC learning including decimation;

FIG. 21 is a flowchart illustrating a flow of operations performed by a collection unit;

FIG. 22 is a diagram illustrating exemplary operations of an aging unit;

FIG. 23 is a flowchart illustrating an operation flow of setting processing for setting a non-aging entry performed by an aging unit;

FIG. 24 is a flowchart illustrating an operation flow of aging processing performed by an aging unit; and

FIG. 25 is a flowchart illustrating an operation flow for forcibly deleting an entry of an FDB.

### DESCRIPTION OF EMBODIMENTS

Hereinafter, embodiments are described with reference to the accompanying drawings. The configurations of the embodiments are illustrative, and configurations of embodiments are not limited thereto.

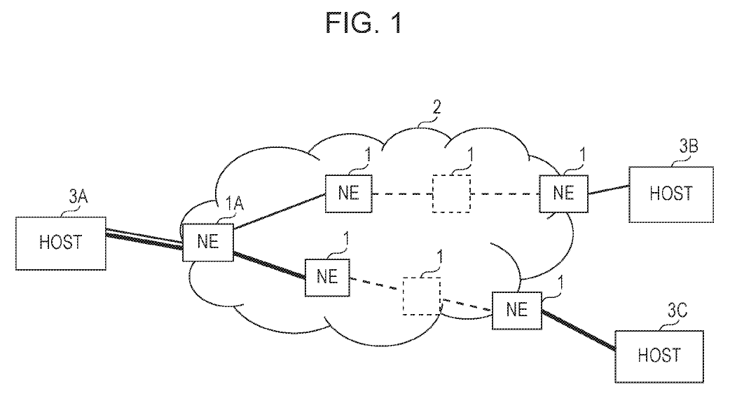

FIG. 1 is a diagram illustrating an exemplary configuration of a network system according to an embodiment. In FIG. 1, the network system includes a network 2 including a plurality of packet transmission apparatuses 1, and a plurality of hosts 3 (or may be referred to as “users”) connected to the network 2. In the description below, a packet transmission apparatus 1 is referred to as a “network element (NE) 1”. A host 3 may be any one of a personal computer (PC), a server machine, a feature phone, a smart phone, a personal digital assistant (PDA), a tablet terminal, and a terminal device having a communication function or a communication device.

In an example illustrated in FIG. 1, a host 3A, a host 3B, and a host 3C are depicted as the plurality of hosts 3. The host 3A is connected to the host 3B and the host 3C via a plurality of NEs 1. The host 3A is connected to an NE 1A that is one of the plurality of NEs 1. A communication path between the host 3A and the host 3B and a communication path between the host 3A and the host 3C are branched at the NE 1A, and respectively reach the host 3B and the host 3C by passing one or more NEs 1 different between the two paths.

Each of the NEs 1 performs the MAC address learning. For example, the NE 1A implements a point-to-multipoint (P-MP) communication between the host 3A and the host 3B and between the host 3A and the host 3C. In the example of FIG. 1, the P-MP communication is implemented between the host 3A and the host 3B and between the host 3A and the host 3C. The number of NEs 1 connecting the NE 1A and the host 3B with each other and the number of NEs 1 connecting the NE 1A and the host 3C with each other may be set to any desired number of 1 or more. The NE 1A may be connected directly to the host 3B and the host 3C.

The connection configuration (network topology) between NEs 1 and between an NE 1 and a host 3 in the network system and the connecting medium of the network are not limited. The connecting medium may be wired (metal cable, optical fiber, and the like) or may be wireless. In the description below, “MAC address learning” may be abbreviated as “MAC learning”.

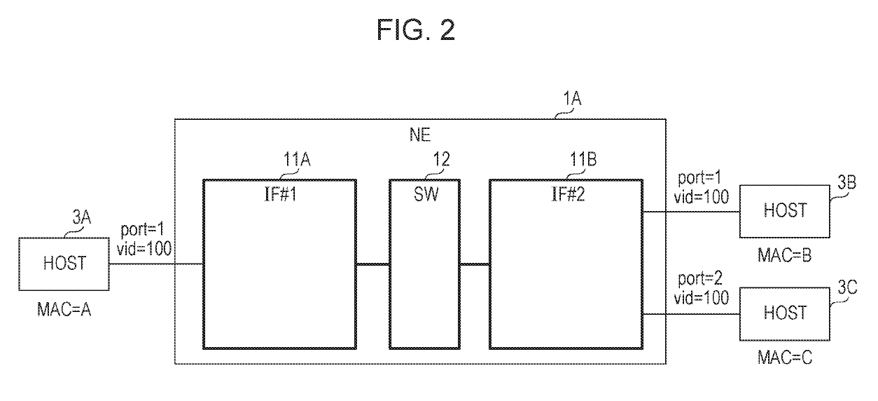

FIG. 2 is a diagram focused on an NE 1 of the network system illustrated in FIG. 1. In FIG. 2, the NE 1A is focused as an example. In FIG. 2, for simplifying the description, it is assumed that hosts 3A, 3B, and 3C are directly connected (accommodated) to the NE 1A.

The NE 1A includes two interface (IF) cards 11 (IF card 11A (IF#1) and IF card 11B (IF#2)) and a switch (SW) card 12. The host 3A has a MAC address “A”, and a connection port to the NE 1A is Port#1 of IF#1 (IF#1, Port#1). The host 3B has a MAC address “B”, and a connection port to the NE 1A is Port#1 of IF#2 (IF#2, Port#1). The host 3C has a MAC address “C”, and a connection port to the NE 1A is Port#2 of IF#2 (IF#2, Port#2). The hosts 3A to 3C belong to the same virtual local area network (VLAN). The identifier (ID) of the VLAN (VLAN-ID (vid)) to which the hosts 3A to 3C belong is “100”.

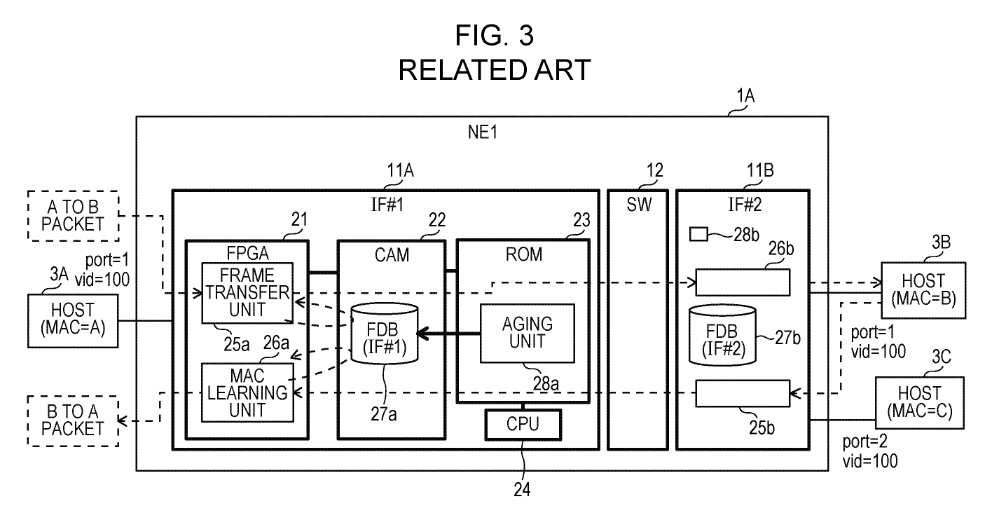

FIG. 3 is a diagram illustrating MAC address learning according to a related technology. Processing of the MAC address learning in the related technology is described below with respect to the following (1) to (3).

(1) Transfer of an input packet: processing at an input side (Ingress (IG) transfer)

(2) Learning of MAC address: processing at an output side (Egress (EG) learning)

(3) Deletion of learnt information: deletion due to aging timeout (aging processing), deletion in accordance with an instruction from an NE operator (user)

Configuration of the MAC address learning is described. As illustrated in FIG. 3, the IF card 11A (IF#1) includes a field programmable gate array (FPGA) 21, a content addressable memory (CAM) 22, a read-only memory (ROM) 23, and a central processing unit (CPU) 24.

The FPGA 21 operates as a frame transfer unit 25 and a MAC learning unit 26. The CAM 22 includes a forwarding database (FDB) 27. The FDB is also referred to as a forwarding table. The CPU 24 performs processing as an aging unit 28 by executing a program stored in the ROM 23 (the CPU 24 operates as the aging unit 28). The IF card 11B (IF#2) has a configuration identical with that of the IF card 11A. However, FIG. 3 illustrates a frame transfer unit 25, a MAC learning unit 26, an FDB 27, and an aging unit 28 included in IF#2, and illustration of other units is omitted.

In the description below, the frame transfer unit 25, the MAC learning unit 26, the FDB 27, and the aging unit 28 in IF#1 are referred to as a “frame transfer unit 25a”, a “MAC learning unit 26a”, an “FDB 27a”, and an “aging unit 28a”, respectively. The frame transfer unit 25, the MAC learning unit 26, the FDB 27, and the aging unit 28 in IF#2 are referred to as a “frame transfer unit 25b”, a “MAC learning unit 26b”, an “FDB 27b”, and an “aging unit 28b”, respectively. When these units are not distinguished from each other, they are referred to as a “frame transfer unit 25”, a “MAC learning unit 26”, an “FDB 27”, and an “aging unit 28” respectively.

The frame transfer unit 25 performs the above-described processing of (1) (IG transfer). The MAC learning unit 26 performs the above-described processing of (2) (EG learning). The aging unit 28 performs the aging processing of the above-described (3).

Hereinafter, the frame transfer unit 25, the MAC learning unit 26 and the aging unit 28 are described. In FIG. 3, a MAC frame (or “packet”) addressed to the host 3B is transmitted from the host 3A. On the other hand, a packet addressed to the host 3A is transmitted from the host 3B.

The frame transfer unit 25 performs the IG transfer. That is, the frame transfer unit 25 transfers an input packet. For example, in FIG. 3, the frame transfer unit 25a of IF#1 acquires, from the FDB 27a, destination information of a packet that IF#1 has received from the host 3A. When the packet is addressed to the host 3B, the destination information is “IF#2, Port#1” and “vid=100”. The packet is transmitted to the SW card 12. The SW card 12 transmits the packet to IF#2 on the basis of the destination information.

The MAC learning unit 26 performs the EG learning. For example, the MAC learning unit 26 of IF#2 acquires data on the packet transferred from IF#1 to IF#2 and updates the FDB 27b. Thereafter, the packet is transferred to the host 3B.

IF#2 receives a packet addressed to the host 3A from the host 3B. In this case, the frame transfer unit 25b of IF#2 performs the IG transfer. That is, like the frame transfer unit 25a of IF#1, the frame transfer unit 25b acquires destination information of the packet from the FDB 27b and transmits the packet to the SW card 12. The SW card 12 transfers the packet to IF#1 on the basis of the destination information.

The MAC learning unit 26a of IF#1 performs the EG learning. That is, like the MAC learning unit 26b of IF#2, the MAC learning unit 26a acquires data on the packet transferred from IF#2 to IF#1 and updates the FDB 27a. The packet is transferred to the host 3A.

The aging unit 28 performs the aging processing. The aging unit 28 checks, at regular intervals, an FDB 27 of an IF card 11 in which the aging unit 28 is implemented, and deletes entries not updated for a predetermined period of time from the FDB 27. The entries of the FDB 27 may be deleted in accordance with a deletion command from an administrator of the NE 1A.

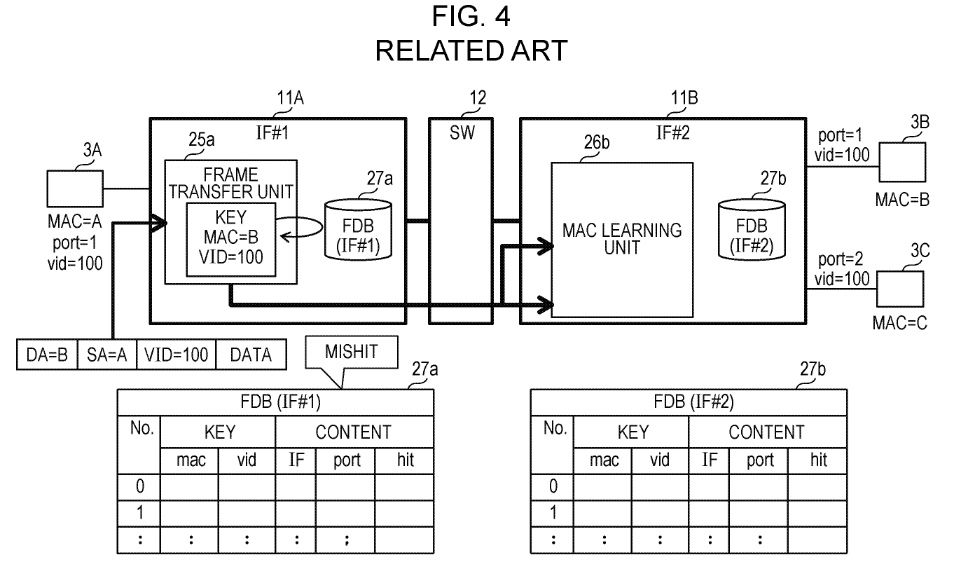

FIGS. 4 to 8 are diagrams illustrating details of a MAC address learning according to the related technology. In FIG. 4, it is assumed that both the FDB 27 (27a) of IF#1 and the FDB 27 (27b) of IF#2 are in an unlearnt state.

Assume that a packet is transmitted from the host 3A to the host 3B when both the FDB 27a and the FDB 27b are in the unlearnt state. As illustrated in FIG. 4, the packet (MAC frame) includes a destination MAC address (Destination Address: DA), a transmission source MAC address (Source Address: SA), a VLAN-ID (VID), and data (payload) to be transmitted. The packet addressed to the host 3B has values of DA=B, SA=A, and VID=100 as destination information.

Upon receiving the packet, the frame transfer unit 25a of IF#1 performs IG transfer (unlearnt). That is, the frame transfer unit 25a acquires DA and VID from the input packet and searches the FDB 27a. The FDB 27a stores a key and content in association with each other. Since the FDB 27a is in the unlearnt state, an entry corresponding to “DA=B” and “VID=100” is not hit.

In this case, the frame transfer unit 25a multicasts (or called flooding) the packet to the host 3B and the host 3C belonging to the same VID (vid=100). A multicast address “M” is set as DA of the packet. As internal control information within the packet transmission apparatus 1, an identifier (IF number) of an IF card 11 and an identifier (port number) of a port of the transfer destination are assigned (stacked) to the packet. Specifically, “IF#2, Port#1” corresponding to the host 3B and “IF#2, Port#2” corresponding to the host 3C are stacked to the packet. At that time, any duplicating identifier of the IF card 11 may be aggregated. In the preceding stage of the frame transfer unit 25a, the FPGA 21 stacks an IF number and a port number “IF#1, Port#1” corresponding to the SA to the packet. The packet is transmitted to the SW card 12. The SW card 12 sends each packet to IF#2 on the basis of the identifier “IF#2” of the IF card 11 of the transfer destination.

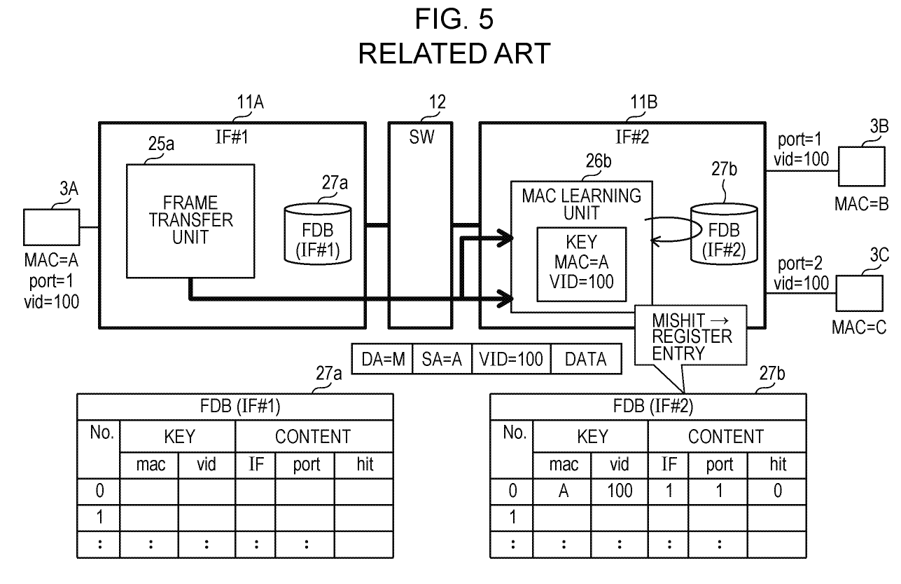

As illustrated in FIG. 5, the MAC learning unit 26b of IF#2, which receives the packet from the SW card 12, performs the EG learning (unlearnt). That is, the MAC learning unit 26b acquires SA and VID (SA=A, vid=100) of the received packet and searches the FDB 27b. The FDB 27b has an identical data structure with the FDB 27a and stores therein a key and content in association with each other.

Since the FDB 27b is in the unlearnt state at this point, an entry corresponding to “SA=A” and “vid=100” is not hit. In this case, the MAC learning unit 26b registers an entry containing data on the transmission source into the FDB 27b as data on the packet. Specifically, “SA=A”, “vid=100”, “IF#1”, and “Port#1” are registered. A hit value included in the content is set to “0”. The hit value is a parameter used for aging the entry. An entry with a hit value of a predetermined value is deleted from the FDB 27.

By registering an entry in the FDB 27b, IF#2 learns “the host 3A of MAC=A is under (accommodated in) Port#1 of IF#1”. The MAC learning unit 26b deletes “IF#1” and “Port#1” stacked into the packet. This is because the information is internal information and is no longer used after the registration of the entry. Thereafter, the packet is transmitted to the host 3B and host 3C on the basis of an IF number and port number of the transfer destination stacked into the packet. An IF number is a number assigned to respective IF cards 11, and a port number is a number assigned to respective ports of respective IF cards 11.

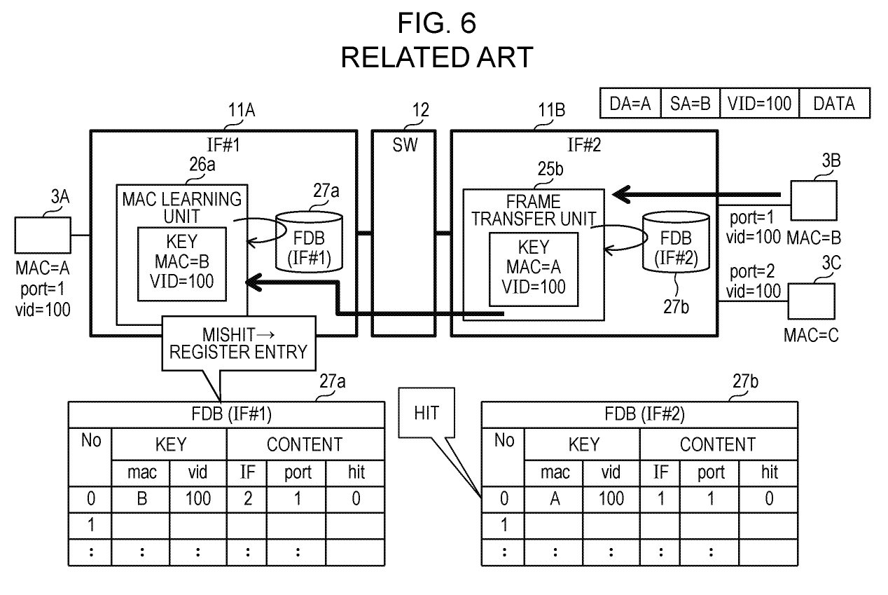

FIG. 6 illustrates a case in which a packet addressed to the host 3A is transmitted after information of the host 3A has been learnt by IF#2. The packet received by IF#2 is inputted into the frame transfer unit 25b. The frame transfer unit 25b performs the IG transfer (learnt). That is, the frame transfer unit 25b acquires “DA=A” and “vid=100” from the packet and searches the FDB 27b for a corresponding entry.

At this point, the entry corresponding to DA and VID has been registered (learnt). Thus, the entry (entry with an entry number of 0) corresponding to DA and VID is hit. The frame transfer unit 25b stacks the content (destination information: “IF#1” and “Port#1”) of the hit entry into the packet and sends the packet to the SW card 12. The SW card 12 transfers the packet to IF#1 on the basis of the destination information. The IF number and port number (IF#2, Port#1) of the host 3B are stacked into the packet by the FPGA 21.

In IF#1, the MAC learning unit 26 (or “MAC learning unit 26a”) performs the EG learning (unlearnt) of the packet. That is, the MAC learning unit 26a acquires SA and VID of the packet and searches the FDB 27a. No corresponding entry is hit. Therefore, the MAC learning unit 26a registers an entry (MAC=B, vid=100, IF#2, Port#1) for the host 3B into the FDB 27a as data on the packet. Thus, “information on a transmission source of a packet” is stored in an entry of the FDB 27. The MAC learning unit 26a deletes “IF#2, Port#1” from the packet.

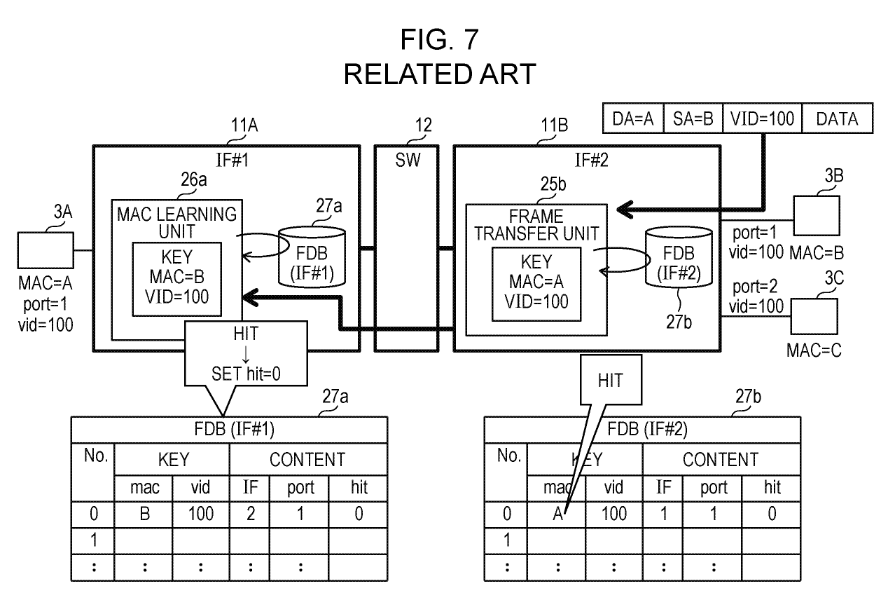

FIG. 7 assumes that a packet addressed to the host 3A is transmitted from the host 3B. In IF#2, the frame transfer unit 25b performs the IG transfer (learnt). The frame transfer unit 25b acquires, from the FDB 27b, an IF number and port number in an entry (entry number “0”) corresponding to DA and VID. The frame transfer unit 25b assigns the IF number and port number to the packet and sends the packet to the SW card 12. Thus, the frame transfer unit 25 transfers, on the basis of the FDB 27, a packet addressed to a transfer source of a packet which has been subjected to the MAC address learning. The SW card 12 transfers the packet to IF#1.

In IF#1, the MAC learning unit 26a performs the EG learning (learnt). In this case, an entry (entry number “0”) corresponding to the packet is hit in the search of the FDB 27a. Then, the MAC learning unit 26a sets (resets) the hit value to 0. Thereafter, the packet is transferred to the host 3A. Thus, the hit value is reset when a corresponding entry is hit by search in the EG learning of the MAC learning unit.

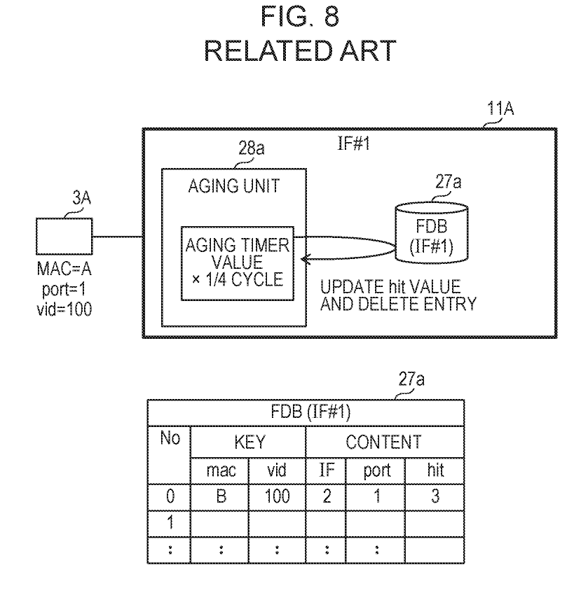

FIG. 8 illustrates an example of deletion of the learnt information. There are two methods for deleting an entry. One method is to delete an entry with “aging timeout” as a trigger (deletion method_1: referred to as aging processing). Another method is to delete an entry with command input from a user of the NE 1 as a trigger (deletion method_2).

In the deletion method_1 (aging processing), the aging unit 28 (aging unit 28a in FIG. 8) checks the hit value of each entry registered in the FDB 27 (FDB 27a in FIG. 8) at predetermined intervals. The interval is, for example, an interval corresponding to ¼ of the value of the aging timer set by the user of the NE 1. However, length of the interval may be set as appropriate.

The aging unit 28 checks the hit value of each entry of the FDB 27 at the intervals. The check is performed as follows: The aging unit 28 increments (adds 1) the hit value. If the incremented hit value reaches a predetermined upper limit value (for example, “3”), the aging unit 28 deletes an entry with the hit value having reached the upper limit value.

As described above, the hit value of an entry hit in the EG learning is reset (set to 0). Thus, an entry hit by the EG learning within a time length (period) set as an aging timer is not deleted. The upper limit value is determined depending on a frequency of the entry check within a period defined by the aging timer.

In the deletion method_2, a corresponding entry is deleted by command input of an entry number and key (KEY: MAC address and VID in the example of FIG. 8) designated by the user.

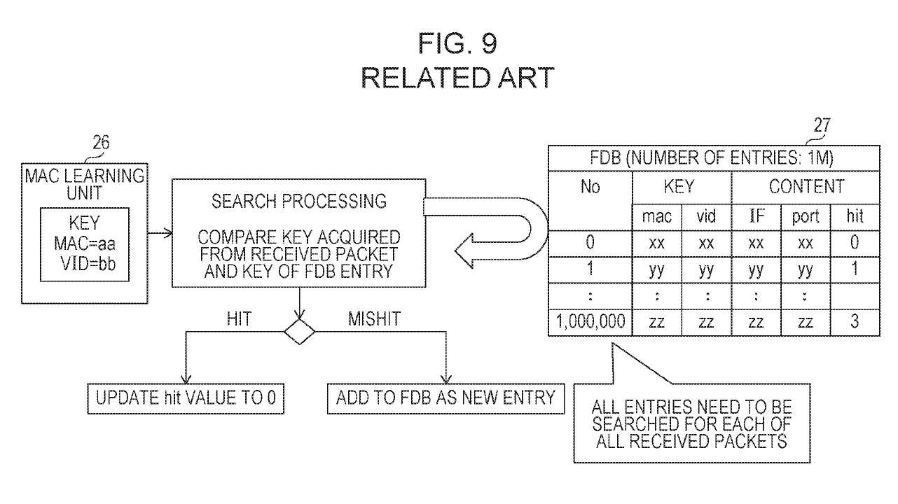

FIG. 9 is a diagram illustrating problems in the related technology. As illustrated in FIG. 9, in the EG learning, the MAC learning unit 26 acquires information (MAC address and VID) used as a key from a packet and compares the acquired key with keys of respective entries within the FDB 27 (search processing). In the search processing, when an entry in which the same MAC address and VID are registered is found, it is determined that the entry is hit, and the hit value is updated to 0. When an entry matching the acquired key is not found, it is determined as a mishit, and the key acquired from the packet is added to the FDB 27 as a new entry. The search processing is performed for all entries registered in the FDB 27 for each of received packets. As illustrated in FIG. 9, when there are 1 million entries, the comparison is performed 1 million times.

In recent years, the number of entries registered in the FDB 27 tends to increase as the number of users (hosts) increases. Also, in order to cope with the increase of the number of users, there is a tendency to improve the communication rate (speed up). Therefore, in the search processing described above, load of the search processing increases as the number of packets or the number of entries increases. As load of the search processing increases, there is a possibility that the search processing is congested, and congestion of the search processing affects packet transfer and thereby decreases the throughput.

Likewise, the aging processing is processing involving access to entries of the FDB 27. Therefore, as the number of entries of the FDB 27 increases, load of the aging processing increases. The following description of the embodiments, a packet transmission apparatus (NE) capable of reducing load of the MAC learning and aging processing is described. Reduction of load of the MAC learning and aging processing may reduce impacts on the packet transfer. Also, by reducing the load, an effect of reducing power consumption of the packet transmission apparatus and an effect of suppressing heat generation may be expected.

### First Embodiment

Hereinafter, a packet transmission apparatus according to a first embodiment is described. The packet transmission apparatus according to the first embodiment includes a table configured to store therein an entry containing information on a transmission source of a packet, and a transfer unit configured to transfer a packet addressed to the packet transmission source on the basis of the table. Further, the packet transmission apparatus includes a learning unit configured to perform learning such that when an entry containing information on the transmission source of the received packet is not found by searching the table, register an entry of information on the transmission source into the table, and when an entry containing information on the transmission source of the received packet is found by searching the table, update the entry found by the search. Further, the packet transmission apparatus includes an aging unit configured to delete, from the table, an entry not updated for a predetermined period of time. Further, the packet transmission apparatus includes a decimation unit configured to exclude, from the target of the learning, a packet identified by a predetermined identifier during a time zone determined on the basis of information indicating the reception state of packets identified by the predetermined identifier. Further, the packet transmission apparatus includes a setting unit configured to set an entry corresponding to a packet identified by the predetermined identifier as a non-aging entry.

In the first embodiment, the MAC learning is described as an example of learning processing. However, the learning processing may be learning of another address such as an internet protocol (IP) address. A MAC frame is an example of a “packet”. Besides a MAC frame, a “packet” may include various types of data block, such as an IP packet, which serves as a unit of transmission.

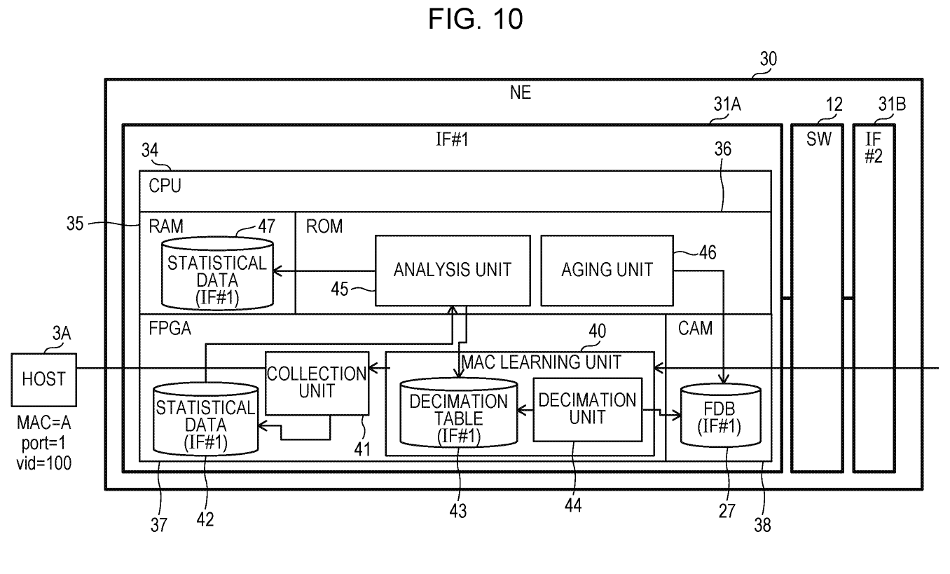

FIG. 10 illustrates an exemplary configuration of an NE 30 according to the first embodiment. The NE 30 may be used in place of the NE 1A illustrated in FIG. 1. That is, the NE 30 is connected to the host 3A, the host 3B, and the host 3C in the description of the related technology, directly or via one or more relay nodes (such as NE). However, in FIG. 10, the host 3B and the host 3C are omitted.

The NE 30 includes an IF card 31 (IF card 31A (IF#1), an IF card 31B (IF#2)), and an SW card 12 (see FIG. 2). The IF card 31 includes a CPU 34, a random access memory (RAM) 35, a ROM 36, an FPGA 37, and a CAM 38, which are mutually connected via a bus (not illustrated).

The FPGA 37 operates as a MAC learning unit 40, a collection unit 41 for collecting statistical information, and a decimation unit 44. The FPGA 37 includes a memory (not illustrated) in which a storage area 42 for storing statistical data is created. The MAC learning unit 40 includes a decimation table 43. Likewise the related technology, the CAM 38 stores therein an FDB 27.

The CPU 34 operates as an analysis unit 45 for analyzing statistical information and an aging unit 46 by executing a program stored in the ROM 36. The RAM 35 is used as a storage area for storing data. The RAM 35 includes a storage area 47 for storing statistical data. Although not illustrated, the IF card 31B has an identical configuration with the IF card 31A.

The FPGA 37 includes a frame transfer unit 25 (FIG. 3) likewise the related technology (omitted in FIG. 10), and performs the IG transfer in the description of the related technology. The MAC learning unit 40 performs the EG learning in the description of the related technology. The aging unit 46 performs the aging processing in the description of the related technology. As the IG transfer, the EG learning, and the aging processing are described above, the repeated description thereof is omitted here. However, a time zone during which the MAC learning and the aging processing are not performed is provided in the IF card 31 for predetermined packets. Details thereof are described later.

A programmable logic device (PLD) other than the FPGA or a semiconductor device such as an integrated circuit (IC) including a large-scale integration (LSI) and an application specific integrated circuit (ASIC) may be used in place of the FPGA 37. Operation of the FPGA 37 as the analysis unit 45 or the aging unit 46 or both may be implemented by a PLD or an integrated circuit.

The FDB 27 is an example of a “table”. The frame transfer unit 25 (FPGA 37) is an example of “transfer unit”. The MAC learning unit 40 (FPGA 37) is an example of a “learning unit”. The collection unit 41 (FPGA 37) is an example of an “addition unit”. The analysis unit 45 (CPU 34) is an example of “generation unit”. The aging unit 46 (CPU 34) is an example of an “aging unit” or a “setting unit”. The RAM 35 is an example of a “storage unit”. The CPU 34 is an example of a “processor”, a “control unit”, or a “controller”. Each of the ROM 36, RAM 35, the memory of FPGA 37, and the CAM 38 is an example of a “storage unit” or a “computer-readable storage medium”.

The IF card 31A operates in the EG learning as follows. The following operation is performed in each IF card 31. For each “host (packet)” identified by an index, the collection unit 41 counts, as statistical data, the number of received packets during each time zone obtained by dividing a predetermined period of time (predetermined interval) by a unit time. For example, when the predetermined period of time is one day and the unit time is 30 minutes, the number of received packets during each of 48 time zones is collected as statistical data. The statistical data is stored in the storage area 42. The predetermined period of time (predetermined interval) and the length of the unit time may be set as appropriate.

The index is a minimum unit for identifying the user (host 3) in the EG learning. The index is an identifier of a packet as well. The index is used as an identifier (decimation check identifier) for determining decimation. Further, the index is handled as a unit for collecting statistical data. The index is an example of a “packet identifier”.

The analysis unit 45 (CPU 34) analyzes statistical data stored in the storage area 42. The analysis unit 45 stores statistical data obtained from the storage area 42 into the storage area 47 of the RAM 35 and analyzes the statistical data. For example, the analysis unit 45 stores statistical data stored in the storage area 42 into the storage area 47 of the RAM 35 every time a predetermined period of time elapses. In this case, after the statistical data is collected, the statistical data stored in the storage area 42 is cleared (deleted). Clearance of the data may be performed by the analysis unit 45 or by the FPGA 37. The analysis unit 45 may analyze statistical data by moving or copying part of statistical data stored in the storage area 42 to the storage area 47 in a cycle shorter than the predetermined period of time. For example, statistical data for a unit time may be moved to the storage area 47 for analysis every time the unit time elapses. Statistical data is an example of “information indicating the reception state of packets”.

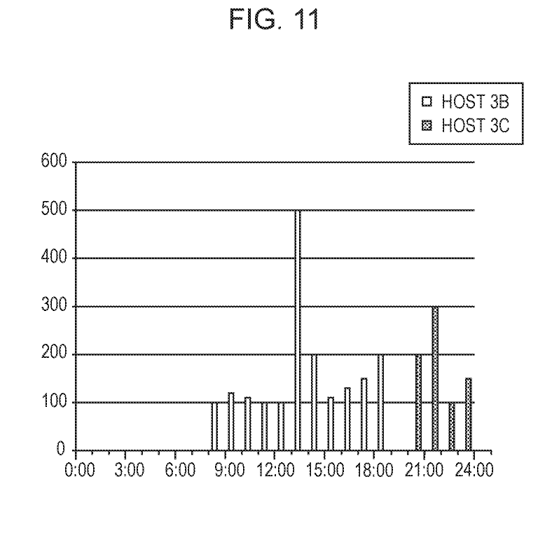

Analysis by the analysis unit 45 provides data indicating the usage (reception state of packets in the NE 30) of the network 2 (FIG. 1) for each of users during a predetermined period of time. FIG. 11 is a graph indicating an example of the usage of the network 2, which is obtained through analysis by the analysis unit 45. The graph is illustrated just for description and the analysis unit 45 does not necessarily create the graph.

Graph of FIG. 11 illustrates usage (reception state of packets in the NE 1A) of the network 2 by the host 3B and host 3C where the predetermined period of time is one day, as an example. According to the graph, the host 3B uses the network 2 between 08:00 and 19:00 for communication. On the other hand, the host 3C uses the network 2 between 20:00 and 24:00 for communication.

On the basis of the graph, for example, it may be considered that the host 3B and the host 3C transmit packets by using the network 2 during a similar time zone of a next predetermined period of time (next day). When a protocol involving retransmission control is used as a transport layer protocol of a packet, entries registered in the FDB 27 are used for transferring (IG transfer) an ACK (acknowledge) packet. Protocols involving retransmission control include, for example, the transmission control protocol (TCP) and the stream control transmission protocol (SCTP).

Thus, during the used time zone, necessity of deleting an entry by the aging processing is low compared with the unused time zone. In view of this, it is preferable to stop the aging processing during the used time zone to reduce load by access to the FDB 27 for aging. On the other hand, the search processing for a registered entry in the MAC learning is performed for setting a hit value of the entry of the FDB 27 to 0 (to avoid entry deletion by aging). If the entry is not deleted by stopping the aging processing, the search processing of the registered entry does not needed to be performed. Avoiding the search processing reduces load due to the MAC learning.

The analysis unit 45 obtains, by analyzing statistical data, data indicating the used time zone for each host 3 as data indicating usage of the network. The aging unit 46 sets, for example, the hit value of the entry to a value (0xFF) out of the setting range so as not to perform the aging processing during the used time zone of each host 3. The setting may be performed by the aging unit 46 at regular intervals, or a timer may be set so as to automatically set the hit value during the used time zone to the value (0xFF) out of the setting range. When performing the setting at regular intervals, length of one interval may be set as appropriate. The hit value is an example of a “value which becomes a predetermined value as time elapses without updating the entry”, and the value out of the setting range is an example of a “special value”.

The analysis unit 45 also generates or updates the decimation table 43. The decimation table 43 stores therein information indicating the used time zone and the unused time zone of each of hosts 3. The decimation unit 44 determines, with reference to the decimation table 43, whether a packet of the EG learning target received by the NE 30 is a decimation target. When the packet is a decimation target, the MAC learning unit 40 excludes the packet from the EG learning target. Thus, search processing of the FDB 27 with respect to the packet is skipped (avoided). Determination as to whether the packet is a target of the EG learning is performed by using an identifier (index) of the packet obtained from the packet and the decimation table 43. For example, when the present time belongs to the used time zone of the packet identified by the index, the packet is determined as a decimation target.

The EG learning in the IF card 31A for the host 3B and the host 3C is described above with reference to FIG. 11. The EG learning for the host 3A is performed in the IF card 31B. In this case, data indicating the used time zone of the host 3A is generated in the IF card 31B on the basis of statistical data using the above-described method. Then, during the used time zone of the host 3A, the decimation unit 44 avoids the MAC learning and aging processing for packets from the host 3A. During the used time zone of the host 3A, the aging unit 46 avoids the entry deletion.

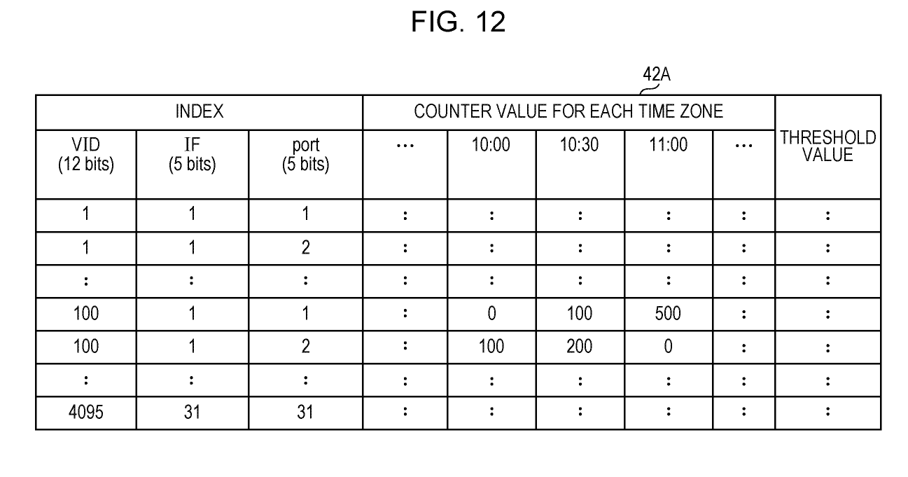

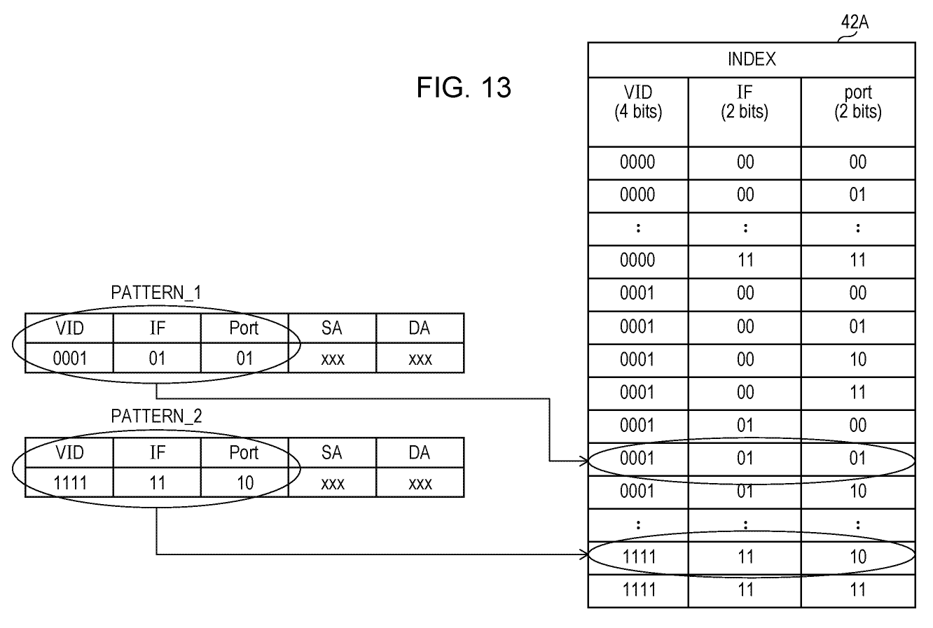

Next, details of statistical data collected by the collection unit 41 are described. FIG. 12 illustrates an exemplary data structure of a statistical table stored in the storage area 42 for storing statistical data. FIG. 13 illustrates an exemplary method of the index search. The storage area 42 for storing statistical data stores therein, as an example, a statistical table 42A such as illustrated in FIG. 12. The statistical data is stored in the statistical table 42A.

The statistical table 42A stores therein a plurality of entries (records) including an index which is an identifier of a host 3 (user), a counter value (number of received packets) for each of time zones corresponding to the index, and a threshold value. The statistical table 42A prestores therein entries of all patterns of a bit string, as an index, which includes serially arranged values (bit values) of a “VID”, an “IF number” and a “port number” which are elements of the index.

The data item (parameter) constituting an element of the index may be set as appropriate. In the first embodiment, “VID”, “IF number”, and “port number” are set as elements of the index. For example, “IF number” and “port number” may be used as the index by excluding VID″. The elements of the index may be determined as appropriate in accordance with the range of the hosts 3 (users) included in one index. For example, an element of the index may be defined with a parameter common to a plurality of hosts 3 to aggregate the plurality of hosts 3 to one index.

A counter for each time zone counts the number of received packets (number of reception of a packet) during each time zone. In the example of FIG. 12, time between 00:00 and 24:00 is divided every 30 minutes (unit time), and the number of received packets for each 30 minutes is stored. The threshold value is a threshold value of the number of received packets. As a result of comparison, a time zone where the number of packets is equal to or larger than, or exceeds the threshold value is handled as a time zone excluded (decimated) from the target of the MAC learning and the aging processing. A time zone where the number of packets is below, or equal to or smaller than the threshold value is handled as a time zone where the MAC learning and the aging processing are performed. Length of the unit time and the threshold value may be set as appropriate.

A method for counting statistical data using the statistical table 42A is as follows: Search of the statistical table 42A using the index is performed by the collection unit 41. When a packet is inputted, the collection unit 41 picks up “VID”, “IF number” and “port number” from the packet and obtains a bit string including values (bits) by arranging them in a predetermined order. The predetermined order is a row of “VID”, “IF number” and “port number” in “index” of the statistical table 42A.

In the “index” of the statistical table 42A, all bit patterns of the bit string (index) with “VID”, “IF number” and “port number” arranged in a predetermined order are preregistered. Positions (for example, addresses on the memory) of the respective patterns are predetermined. The FPGA 37 prestores information (correspondence table) indicating a correspondence relationship between the pattern and the position, and calculates a corresponding position of the index obtained from the packet with respect to the bit pattern on the basis of the information indicating the correspondence relationship.

In the examples illustrated in FIGS. 12 and 13, the number of bits of each index element is smaller than the actual number, for sake of simplicity. As an example, assume that “VID” has 4 bits, the IF number has 2 bits, and the port number has 2 bits.

Pattern_1 illustrated in FIG. 13 has VID=“0001”, IF number=“01”, and port number “01”. In this case, an entry located at a position (address) of index “00010101” in the statistical table 42A is indexed. Pattern_2 has VID=“1111”, IF number=“11”, and port number “10”. In this case, an entry located at a position (address) of index “11111110” is indexed.

Thus, in the search of the statistical table 42A, determination as to whether the index matches a value stored in the table is not performed in order from a starting entry. Therefore, an entry corresponding to the packet may be found in the statistical table 42A in a short time.

The FPGA 37 includes a clock (not illustrated), and the collection unit 41 identifies the time zone to which the present time belongs on the basis of the time counted by the clock. The collection unit 41 increments (adds 1 to) a count value, in the entry found by the search, for a time zone to which the present time belongs. Thus, the number of received packets is aggregated for each index unit for each time zone.

Temporal granularity (length of a unit time) in the statistical table 42A and the threshold value compared with the number of received packets may be changed. The temporal granularity and threshold value are changed, for example, by the operator or user of the NE 30. Reflection of the changed temporal granularity and threshold value is implemented every time a predetermined period of time elapses. That is, in the case where the predetermined period of time is one day, reflection of the change is performed once a day at a timing when statistical data in the storage area 42 is cleared by shifting statistical data from the storage area 42 to the storage area 47.

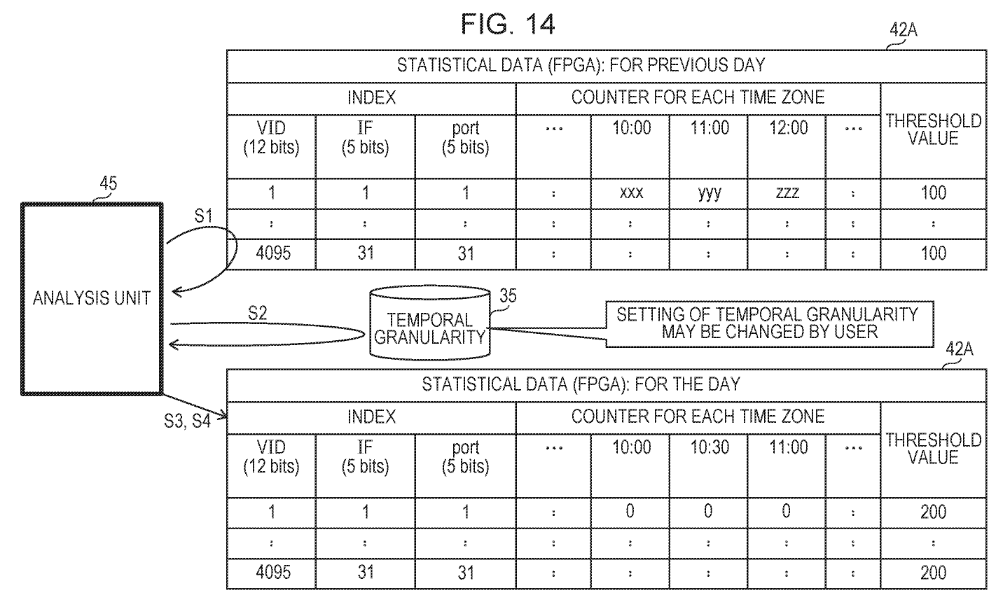

FIG. 14 is a diagram illustrating the change of the temporal granularity and threshold value in the statistical table 42A. In the example of FIG. 14, the temporal granularity and threshold value are changed by the analysis unit 45. The temporal granularity and threshold value may be changed by the collection unit 41. The analysis unit 45 reads statistical data (data stored in statistical table 42A) for a predetermined period of time (for example, previous day) from the statistical table 42A and stores the read statistical data into the storage area 47 of the RAM 35 (S1 of FIG. 14). The temporal granularity in statistical data for the previous day is one hour, and the threshold value is 100 (common to all entries).

At that time, when changing the temporal granularity or threshold value, the analysis unit 45 reads the temporal granularity and threshold value stored in a predetermined area of the RAM 35 (S2 of FIG. 14). Then, the analysis unit 45 clears data stored in the statistical table 42A (S3 of FIG. 14), and sets the temporal granularity and threshold value into the statistical table 42A (S4 of FIG. 14). Thus, the temporal granularity and threshold value in the statistical table 42A are changed. In the example illustrated in FIG. 14, the temporal granularity is changed from one hour to 30 minutes, and the threshold value is changed from 100 to 200.

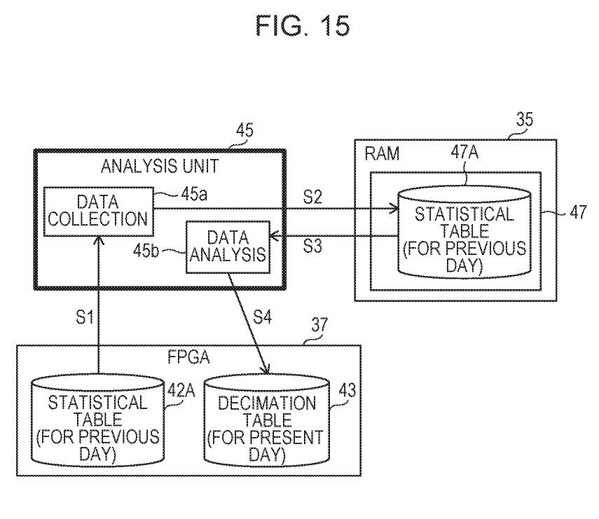

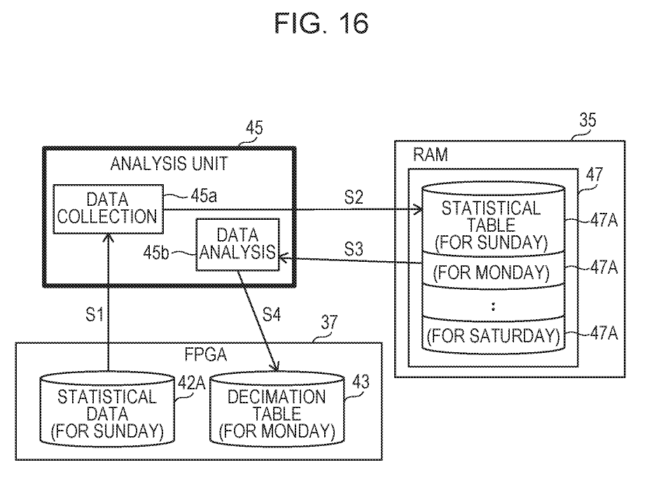

The analysis unit 45 manages and analyzes statistical data (replication of statistical table 42A: referred to as “statistical table 47A”) stored in the storage area 47 of the RAM 35. FIGS. 15 and 16 are diagrams illustrating operations of the analysis unit 45. FIG. 15 illustrates an example in which the analysis unit 45 creates a decimation table 43 for the present day by using statistical data for the previous day. FIG. 16 illustrates an example in which the analysis unit 45 creates a decimation table 43 for this Monday by using statistical data for last Monday out of statistical data for one week.

As illustrated in FIG. 15, the analysis unit 45 performs data collection 45a and data analysis 45b. The analysis unit 45 collects statistical data for the previous day from the statistical table 42A through the data collection 45a (S1 of FIG. 15), and develops statistical data in the storage area 47 of the RAM 35 (S2 of FIG. 15). Thus, the statistical table 47A, which is a replication of the statistical table 42A, is stored in the storage area 47. It is enough that information stored in the statistical table 42A is stored in the storage area 47, and a replication of the statistical table 42A is not necessarily stored in the storage area 47.

Next, the analysis unit 45 reads statistical data stored in the statistical table 47A (S3 of FIG. 15), analyzes the statistical data, and develops (stores) the analysis result into the decimation table 43 through the data analysis 45b (S4 of FIG. 15). Thus, the decimation table 43 for the present day is created.

As illustrated in FIG. 16, the statistical table 47A for one week (7 days) may be stored in the storage area 47 of the RAM 35. That is, the storage area 47 may store statistical data for a plurality of predetermined periods of time. The analysis unit 45 operates similarly to the operations illustrated in FIG. 15 through the data collection 45a and data analysis 45b. However, the decimation table 43 is created on the basis of statistical data for not the statistical data for the previous day but the same day of the last week. In the example of FIG. 16, statistical data of Sunday stored in the storage area 47 is updated, and a decimation table 43 for Monday is created (S1 to S4 of FIG. 16). Thus, the analysis unit 45 may create a decimation table 43 for a certain day of this week through analysis of statistical data of the certain day of the last week (in FIG. 16, Monday).

As described above, the analysis unit 45 may create decimation data (decimation table) for any desired period of time by multi-generation management of statistical data collected from the statistical table 42A and data analysis using the statistical data. A pattern of creating decimation data on the basis of statistical data of the previous day and a pattern of creating decimation data on the basis of statistical data of the last week are described above with reference to FIGS. 15 and 16. Further, for example, by holding statistical data for one month in the storage area 47, an average value or a cumulative value for four weeks may be calculated for each day of the week and decimation data for each day of the week may be set into the decimation table 43.

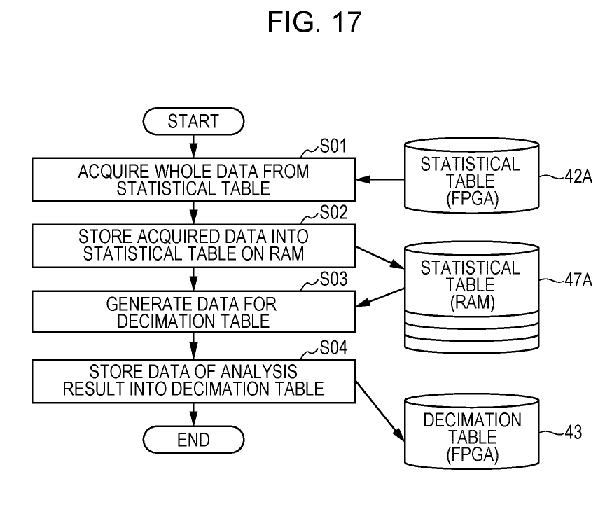

FIG. 17 is a flowchart illustrating an operation flow of the analysis unit 45. The operations illustrated in FIG. 17 are started when a cycle timer, which has been set in accordance with a predetermined period of time, times out. In S01 in FIG. 17, the analysis unit 45 acquires whole data stored in the statistical table 42A.

In S02, the analysis unit 45 stores data acquired in S01 into the statistical table 47A on the RAM 35. Thus, data of the statistical table 42A is stored as the statistical table 47A on the RAM 35.

In S03, the analysis unit 45 generates data for the decimation table 43 by analyzing one or more statistical tables 47A stored in the RAM 35. In S03, the analysis unit 45 determines a method for creating the decimation table in accordance with a setting (preset) of “number of days of statistical data for analysis”. That is, the analysis unit 45 performs the analysis on the basis of information identifying the statistical tables 47A used for generating data (decimation data) for the decimation table, and information indicating a method for generating the decimation data in accordance with the number of used statistical tables 47A and a combination thereof. For example, when generating the decimation data for the present day by using a statistical table 47A for the previous day, data of the statistical table 47A for the previous day may be used as the decimation data. When temporal granularity of the decimation data is larger than temporal granularity of the statistical table 47A, the number of received packets may be recalculated in accordance with the temporal granularity.

In S04, the analysis unit 45 stores the decimation data (data of analysis result) generated in S03 into the decimation table 43. Thus, the decimation table 43 holds the decimation data for a next predetermined period of time.

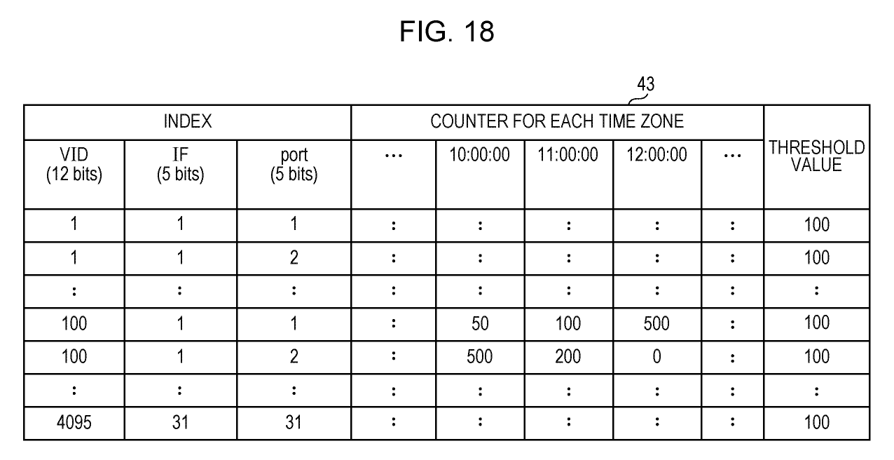

FIG. 18 illustrates an exemplary data structure of the decimation table 43. As described above, the decimation data set in the decimation table 43 is created on the basis of statistical data for a predetermined period of time (for example, previous day). Therefore, as illustrated in FIG. 18, the decimation table 43 may have a similar data structure to the statistical table 42A. However, the decimation table 43 and the statistical table 42 do not necessarily have a similar data structure.

For example, in the example of the decimation table 43 illustrated in FIG. 18, the number of received packets is stored as a count value for each time zone not every 30 minutes as illustrated in FIG. 12, but every one hour. Thus, temporal granularity of the decimation table 43 may or may not match temporal granularity of the statistical table 42A. The decimation table 43 may store information indicating comparison result between the counter value and the threshold value instead of storing the counter value and threshold value. For example, a bit (for example, “1”) indicating a decimation target may be set for a time zone where the counter value exceeds the threshold value, and a bit (for example, “0”) indicating a non-decimation target may be set for a time zone where the counter value does not exceed the threshold value. In this case, comparison between the counter value and threshold value is not performed by the decimation unit 44, and whether data is a decimation target or not is determined by the decimation unit 44 on the basis of the bit value.

When a packet is inputted, the decimation unit 44 searches the decimation table 43 for an entry corresponding to the packet by using an index acquired from the packet. Similarly to the statistical table 42A, the decimation table 43 has entries corresponding to all bit patterns of the index. Thus, on the basis of the index acquired from the packet, it is possible to search the decimation table 43 for an entry corresponding to the packet in a short time.

The decimation unit 44 compares the number of packets for the present time zone in the decimation table 43 in the identified entry with the threshold value. As a result of comparison, when the number of packets exceeds the threshold value, the packet is excluded from the target of the MAC learning, and when not exceeding, the packet is included in the target of the MAC learning.

In the example illustrated in FIG. 18, the counter value of the packet with VID=100, IF number=1, and port number=1 is “50” from 10:00:00 to 10:59:59, “100” from 11:00:00 to 11:59:59, and “500” from 12:00:00 to 12:59:59. The counter value of the packet with VID=100, IF number=1, and port number=2 is “500” from 10:00:00 to 10:59:59, “200” from 11:00:00 to 11:59:59, and “0” from 12:00:00 to 12:59:59. The counter value for all of remaining time zones are assumed to be 0. As the threshold value, “100” is set for all indices, and determination is made depending on whether the counter value exceeds the threshold value or not.

In this case, a packet with VID=100, IF number=1, and port number=1 is excluded (decimated) from the target of the MAC learning and aging processing during a time zone between 12:00:00 and 12:59:59, and becomes the target of the MAC learning and aging processing during the remaining time zones. On the other hand, a packet with VID=100, IF number=1, and port number=2 is excluded (decimated) from the target of the MAC learning and aging processing during time zones between 10:00:00 and 11:59:59, and becomes the target of the MAC learning and aging processing during the remaining time zones. The threshold value may be set in units of indices, VIDs, IF numbers and port numbers. Alternatively, the threshold value may be set for all entries collectively.

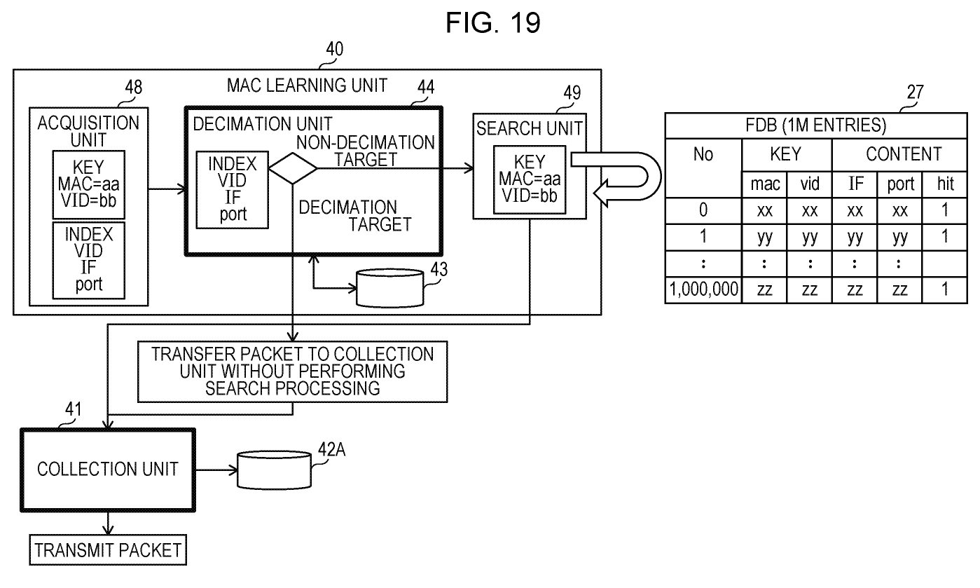

FIG. 19 illustrates operations of the decimation unit 44. In FIG. 19, the MAC learning unit 40 includes acquisition unit 48 for acquiring a key (KEY) and index (INDEX), a decimation unit 44, and a search unit 49.

The acquisition unit 48 acquires a key and an index included in a packet transferred from the SW card 12 to the IF card 31. The Key is a MAC address (SA) and VID. The index is a VID, IF number, and port number.

The decimation unit 44 refers to the decimation table 43 on the basis of the index acquired by the acquisition unit 48 and determines whether the packet is a decimation target. As described above, the decimation unit 44 searches the decimation table 43 for a corresponding entry on the basis of the index of the packet. The decimation unit 44 compares the number of received packets for a time zone to which the present time belongs, in the entry found by the search, with the threshold value, and determines whether the number of received packets exceeds the threshold value. When the number of received packets exceeds the threshold value, the packet is determined as a decimation target, and when not exceeding the threshold value, the packet is determined as a non-decimation target.

When the packet is a non-decimation target as a result of the determination, the search unit 49 performs the search processing on the basis of a key (MAC address and VID). When the packet is determined as a decimation target, the packet is transferred to the collection unit 41 without performing the search processing. Thus, search processing of the search unit 49 is skipped, and no access to the FDB 27 occurs.

The collection unit 41 stores statistical data of the packet into the statistical table 42A stored in the storage area 42. Upon completion of processing of the collection unit 41, the EG learning ends and the packet is transferred toward the destination.

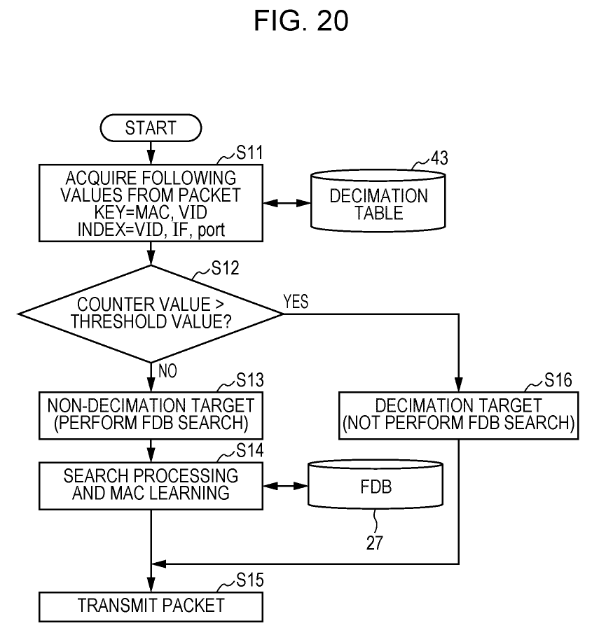

FIG. 20 is a flowchart illustrating an example of the MAC learning including the decimation. The operations illustrated in FIG. 20 are started when the IF card 31 receives a packet from the SW card 12.

In S11, the acquisition unit 48 acquires a key and index from the received packet. Further, the decimation unit 44 searches the decimation table 43 for an entry corresponding to the index.

In S12, the decimation unit 44 determines whether, in the entry identified in S11, a counter value (number of received packets) for a time zone to which the present time belongs exceeds the threshold value. At that time, when the counter value does not exceed the threshold value (No in S12), the packet is determined as a non-decimation target (S13) and the search processing and MAC learning using the FDB 27 are performed (S14). Thereafter, the packet is transmitted to the collection unit 41 (S15).

When the counter value exceeds the threshold value (Yes in S12), the packet is determined as a decimation target (S16) and the search processing and MAC learning using the FDB 27 are skipped, then the packet is transmitted to the collection unit 41 (S15). Determination (recognition) in S13 and S16 on whether the packet is a decimation target does not have to be performed. Thus, S13 and S16 may be omitted.

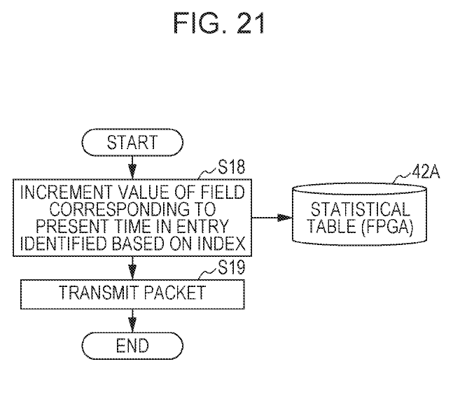

FIG. 21 is a flowchart illustrating operations of the collection unit 41. The operations illustrated in FIG. 21 are started when the packet is received from the decimation unit 44. In S18, the collection unit 41 searches the statistical table 42A for an entry corresponding to an index acquired from the packet, and increments the counter value for a time zone corresponding to the present time (to which the present time belongs) in the entry found by the search. The collection unit 41 transmits the packet to the destination (S19). In S18, since the entry is identified using the index, the processing may be performed in a short time, and thereby packet transmission timing in S19 may be advanced compared with the related technology.

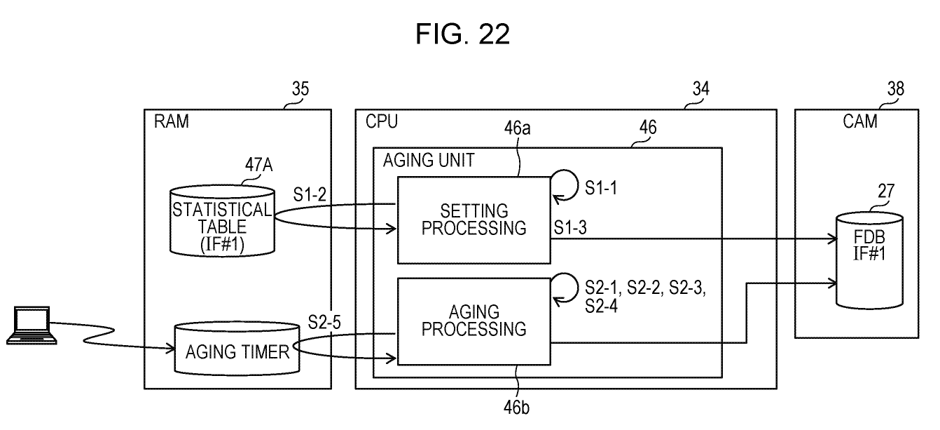

FIG. 22 is a diagram illustrating exemplary operations of the aging unit 46. The aging unit 46 performs setting processing 46a for setting a non-aging entry and aging processing 46b. In the setting processing 46a, the aging unit 46 sets a decimation target entry stored in the FDB 27 to a non-aging entry.

Specifically, the following operations are performed in the setting processing 46a. The setting processing 46a is started, for example, in accordance with the temporal granularity of the statistical table 47A (S1-1 of FIG. 22). That is, the setting processing 46a is started every 30 minutes or every one hour, which is the temporal granularity. The aging unit 46 acquires (extracts), from the statistical table 47A of the RAM 35, an entry which has a field for a time zone to which the present time belongs and in which the number of received packets (counter value) exceeds the threshold value (S1-2 of FIG. 22). Next, the aging unit 46 sets the hit value of an entry stored in the FDB 27, which corresponds to the extracted entry, to “0xFF” representing a non-aging entry (S1-3 of FIG. 22).

In the aging processing 46b, the aging unit 46 performs the following operations. That is, the aging processing 46b is started at a predetermined cycle trigger (cycle corresponding to ¼ of the aging timer) (S2-1 of FIG. 22). The aging unit 46 makes access to each entry of the FDB 27 in either of the descending order or the ascending order. At that time, when the hit value of the entry is “0xFF”, the aging unit 46 skips the entry and makes access to a next entry (S2-2 of FIG. 22).

When the hit value of the entry is a value other than “0xFF”, the aging unit 46 increments (adds 1 to) the hit value of the entry (S2-3 of FIG. 22). When the hit value reaches “4” by incrementing, the aging unit 46 deletes the entry (S2-4 of FIG. 22). Upon completion of the processing for all entries, the aging unit 46 sets a timer which becomes a starting trigger of a next aging processing 46, on the basis of the aging timer value stored in the RAM 35 (S2-5 of FIG. 22). The aging timer value stored in the RAM 35 is set by the operator or user of the NE 30 as appropriate. That is, the aging timer value (interval of the cycle trigger) may be set and changed as appropriate.

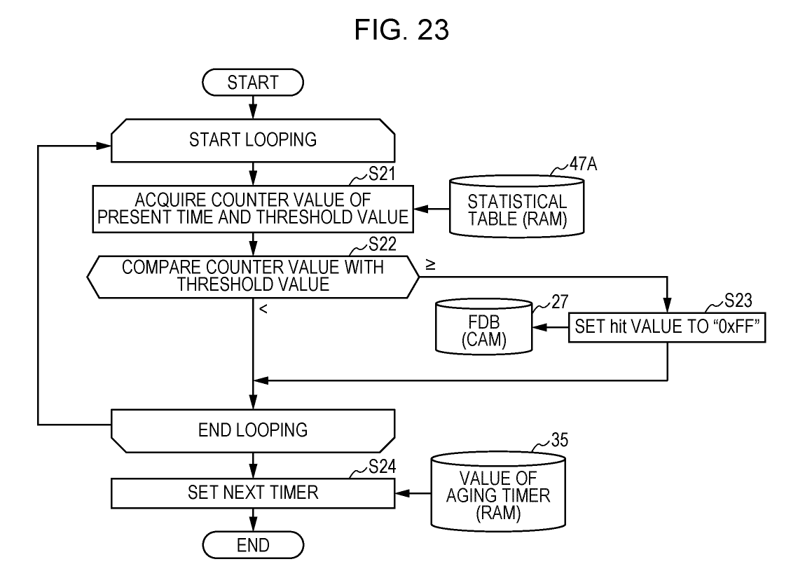

FIG. 23 is a flowchart illustrating operations in the setting processing 46a performed by the aging unit 46. The operations illustrated in FIG. 23 are started upon timeout of the cycle timer. When the setting processing 46a is started, the aging unit 46 performs the following loop operations in order from a starting entry of the statistical table 47A which is the target of the setting processing 46a.

In S21, the aging unit 46 acquires a counter value of the field corresponding to the present time and the threshold value from the target entry. In S22, the aging unit 46 compares the counter value with the threshold value. At that time, when the counter value is equal to or larger than the threshold value, the packet is a decimation target and therefore the processing proceeds to S23. When the counter value is smaller than the threshold value, the packet is a non-decimation target and therefore the aging unit 46 proceeds to the processing of a next entry. In S23, the aging unit 46 sets the hit value of a corresponding entry of the FDB 27 to the value of “0xFF” indicating “non-aging”. Thereafter, the aging unit 46 proceeds to the processing of a next entry.

Upon completion of S21 to S23 for all entries of the statistical table 47A, the processing proceeds to S24. In S24, the aging unit 46 sets the cycle timer for next setting processing 46a with reference to the aging timer value of the RAM 35, and then ends the processing.

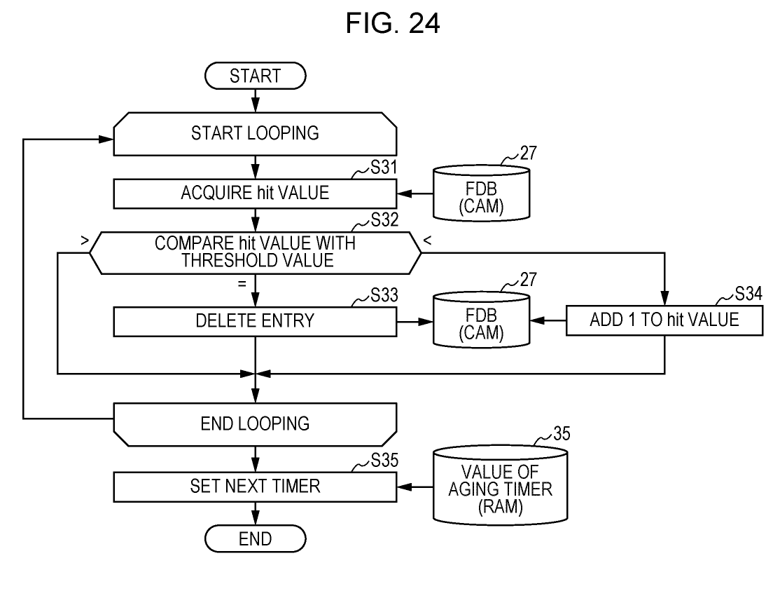

FIG. 24 is a flowchart illustrating operations of the aging processing 46b performed by the aging unit 46. The operations of FIG. 24 are started when the cycle timer times out. When the operations are started, the aging unit 46 performs the following loop operations in order from a starting entry of the FDB 27.

In S31, the aging unit 46 acquires the hit value from the target entry. In S32, the aging unit 46 compares the hit value with a threshold value (aging expiration value). When the hit value is smaller than the threshold value, the aging unit 46 adds 1 to the hit value (S34) and proceeds to processing of the next entry. When the hit value is equal to the threshold value, the aging unit 46 deletes the entry from the FDB 27 (S33) and proceeds to processing of the next entry. When the hit value is larger than the threshold value (hit value=“0xFF”), the entry is a non-target of the aging processing thus the aging unit 46 performs nothing for the entry and proceeds to processing of the next entry.

When the aging processing for all entries has completed, the aging unit 46 sets a cycle timer for triggering next aging processing 46b with reference to an aging timer value of the RAM 35 (S35) and ends the processing.

Instead of S32, it may be determined before S32 whether the hit value is “0xFF” or not. When the hit value is “0xFF”, the aging unit may proceed to processing of the next entry (the determination with the threshold value is skipped), and when the hit value is not “0xFF”, the determination with the threshold value may be performed.

According to the first embodiment, statistical data (statistical table 42A) indicating the reception state of packets for a predetermined period of time is generated, and the decimation table 43 is generated on the basis of the statistical data. Then, for a time zone where the number of received packets having certain identification information (indices) exceeds a threshold value, the search processing and MAC learning of the packet is skipped (avoided) on the basis of the decimation table 43. This reduces load of the MAC learning. This suppresses affecting of load of the MAC learning onto transfer of the packet and thereby reduces decrease in throughput. As load increase of the search processing is avoided, power consumption of the FPGA 37 may be reduced, and an amount of heat generation of the FPGA 37 may be reduced as well.

The setting processing 46a for setting a non-aging entry is performed on the basis of statistical data, and the aging processing of the FDB 27 for the packet is avoided during a time zone where the number of received packets having certain identification information exceeds the threshold value. This reduces load of the aging processing.

### Other Embodiments

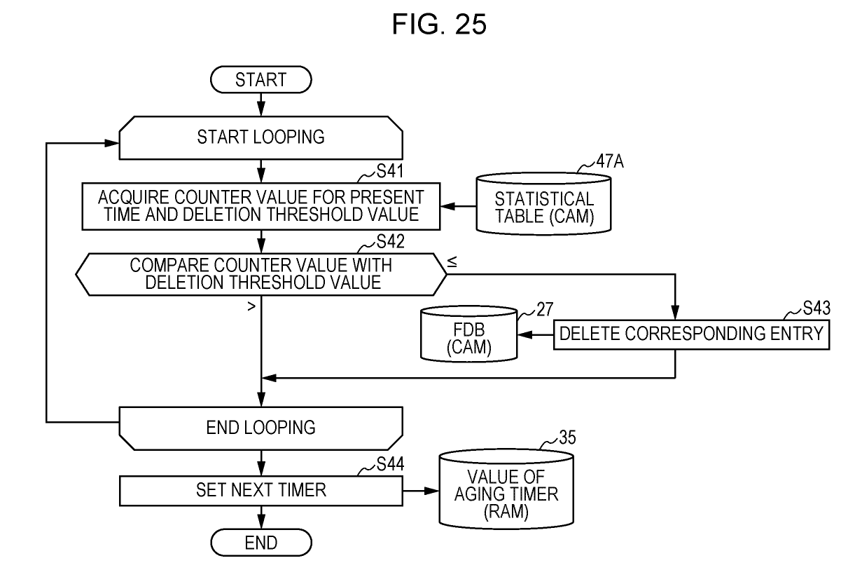

The NE 30 according to the first embodiment may further perform the operations illustrated in FIG. 25. As illustrated in FIG. 12, a time zone where reception of a certain packet is not observed may occur in statistical data stored in the statistical table 42A. During such a time zone, an entry for the certain packet is useless even if registered in the FDB 27. Therefore, during such a time zone, storage capacity of the FDB 27 is efficiently used by forcibly deleting a corresponding entry.

FIG. 25 is a flowchart illustrating an operation flow for forcibly deleting an entry of the FDB 27. These operations may be started, for example, at the same timing as the starting trigger of the setting processing 46a. When the operations are started, the aging unit 46 performs the following loop operations in order from a starting entry of the statistical table 47A. In S41, the aging unit 46 acquires a counter value for the time zone to which the present time belongs and a deletion threshold value from the entry. The deletion threshold value is a threshold value used to determine whether to delete the entry forcibly, and is different from the threshold value for determining whether to set to non-aging entry. The deletion threshold value is preset to the statistical table 42A.

In S42, the aging unit 46 compares the counter value with the deletion threshold value. At that time, when the counter value is equal to or smaller than the deletion threshold value, the aging unit 46 forcibly deletes a corresponding entry (entry containing the same index value) of the FDB 27 (S43), and proceeds to processing of the next entry. When the counter value exceeds the deletion threshold value, the aging unit proceeds to processing of the next entry. Thus, an entry with a counter value exceeding the deletion threshold value is not deleted from the FDB 27.

When the aging processing for all entries has completed, the aging unit 46 sets a cycle timer for triggering the next forcible deletion processing with reference to an aging timer value of the RAM 35 (S44) and ends the processing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A packet transmission apparatus, comprising:
a storage unit configured to
store therein a first table storing therein entries corresponding to respective indices out of plural indices; and
a processor configured to
receive a first packet identified by a first index,
perform a first determination of determining whether a first entry corresponding to the first index is present in the first table,
register an entry corresponding to the first index into the first table in absence of the first entry in the first table,
update the first entry in presence of the first entry in the first table,
determine whether a second entry corresponding to a second index is present in the first table, the second index identifying a destination of the first packet,
transfer the first packet to the destination on basis of the second entry in presence of the second entry in the first table,
perform a second determination of determining whether a third entry is present in the first table, the third entry not being updated for a first period of time,
delete the third entry from the first table in presence of the third entry in the first table,
determine a first time zone on basis of information indicating a reception state of packets identified by the first index,
skip the first determination when the first packet is received during the first time zone,
set the first entry to a non-aging entry when the first packet is received during the first time zone, and
skip the second determination for an entry set to the non-aging entry.

2. The packet transmission apparatus according to claim 1, wherein
the storage unit is configured to
store therein a second table in which entries corresponding to the respective plural indices and containing zone information are stored, the zone information indicating a time zone in which a number of received packets identified by the respective plural indices exceeds a first threshold value, and
the processor is configured to
obtain the first index on basis of the first packet,
obtain an entry corresponding to the first index from the second table,
obtain zone information contained in the obtained entry, and
skip the first determination when a present time belongs to a time zone indicated by the obtained zone information.

3. The packet transmission apparatus according to claim 2, wherein
the second table stores therein entries corresponding to all bit patterns expressed by bit strings representing the respective plural indices, and
the processor is configured to
obtain the entry corresponding to the first index from the second table on basis of a bit pattern representing the first index.

4. The packet transmission apparatus according to claim 2, wherein
the storage unit is configured to
store therein a third table in which entries corresponding to the respective plural indices and containing state information are stored, the state information containing a number of received packets for respective time zones obtained by dividing a predetermined period of time by a predetermined temporal granularity, and
the processor is configured to
generate the second table on basis of the third table.

5. The packet transmission apparatus according to claim 4, wherein
the third table stores therein entries corresponding to all bit patterns expressed by bit strings representing the respective plural indices, and
the processor is configured to
obtain an entry corresponding to the first index from the third table on basis of a bit pattern representing the first index, and
add 1 to a number of received packets for a time zone to which a present time belongs, out of time zones of the entry obtained from the third table.

6. The packet transmission apparatus according to claim 1, wherein
the entries of the first table contain a check value which is changed step by step to become a first predetermined value as time passes without updating the respective entries, and
the processor is configured to
change the check value contained in the respective entries of the first table such that a difference between the check value and the first predetermined value to be smaller as a predetermined time passes without updating the respective entries,
set the check value contained in a fourth entry of the first table to a second predetermined value to set the fourth entry to the non-aging entry,
delete an entry containing the first predetermined value from the first table, and
skip the change of the check value for an entry containing the second predetermined value.

7. The packet transmission apparatus according to claim 4, wherein
the processor is configured to
obtain a third index corresponding to a fourth entry of the third table, the fourth entry containing, as the number of received packets, a first number for a time zone including a present time, the first number exceeding a threshold value contained in the fourth entry, and
set an entry of the first table, which corresponds to the third index, to the non-aging entry.

8. The packet transmission apparatus according to claim 4, wherein
the processor is configured to
obtain a third index corresponding to a fourth entry of the third table, the fourth entry containing, as the number of received packets, a first number for a time zone including a present time, the first number being less than a threshold value contained in the fourth entry, and
delete an entry corresponding to the third index from the first table.

9. A control method, comprising:
receiving, by a computer, a first packet identified by a first index;
performing a first determination of determining whether a first entry corresponding to the first index is present in a first table in which entries corresponding to respective indices out of plural indices are stored;
registering an entry corresponding to the first index into the first table in absence of the first entry in the first table;
updating the first entry in presence of the first entry in the first table;
determining whether a second entry corresponding to a second index is present in the first table, the second index identifying a destination of the first packet;
transferring the first packet to the destination on basis of the second entry in presence of the second entry in the first table;
performing a second determination of determining whether a third entry is present in the first table, the third entry not being updated for a first period of time;
deleting the third entry from the first table in presence of the third entry in the first table;
determining a first time zone on basis of information indicating a reception state of packets identified by the first index;
skipping the first determination when the first packet is received during the first time zone;
setting the first entry to a non-aging entry when the first packet is received during the first time zone; and
skipping the second determination for an entry set to the non-aging entry.
